(19) United States
(12) Patent Application Publication
(10) Pub. No.: US 2026/0355651 A1
(43) Pub. Date: Nov. 12, 2026

(54) DIRECT CONTACT VAPORIZER

(71) Applicant: CAMERON INTERNATIONAL CORPORATION, Houston, TX (US)

(72) Inventors: Z. Frank ZHENG, Sugar Land, TX (US); Rafiqul KHAN, Houston, TX (US); Christopher Stephen KING, Houston, TX (US); Saloma KHEIRALLAH, Houston, TX (US); Ernest Eugene BROWN, Houston, TX (US)

(21) Appl. No.: 19/131,554

(22) PCT Filed: Nov. 21, 2023
(86) PCT No.: PCT/US2023/080627

§ 371 Date: May 21, 2025

Related U.S. Application Data
(60) Provisional application No. 63/384,715, filed on Nov. 22, 2022.

(51) Int. Cl. B01D 1/30; B01D 1/00

(52) U.S. Cl. CPC B01D 1/30; B01D 1/0011; B01D 1/0064

(57) ABSTRACT

Vaporizers that have high fluid mixing are disclosed herein. Such vaporizer has a vessel with a circular cross-section; a heating pathway with a first conduit for withdrawing fluid from the vessel coupled to a heater and a second conduit for returning fluid to the vessel; and a fluid distributor disposed within the vessel and fluidly coupled to the second conduit, the fluid distributor having a conduit to flow fluid into the vessel in an entry direction; and a circular distribution plate having a central inlet coupled to the conduit and a plurality of peripheral outlets, the circular distribution plate defining a plane, wherein each peripheral outlet is fluidly coupled to the central inlet by a flow path that curves in an azimuthal direction, and each peripheral outlet is shaped to direct fluid flow out of the distributor away from the plane of the circular distribution plate along the entry direction.

### CROSS-REFERENCE TO RELATED APPLICATIONS

The present application claims priority benefit of U.S. Provisional Application No. 63/384715, filed Nov. 22, 2022, the entirety of which is incorporated by reference herein and should be considered part of this specification.

### FIELD

This patent application relates to apparatus and methods for direct contact vaporization. Specifically, this application describes methods and apparatus for direct contact vaporization via rotational fluid injection.

### BACKGROUND

Monoethylene glycol (MEG) is commonly used to suppress formation of natural gas hydrates, in order to prevent formation of hydrate crystals in operating equipment. Fluids carrying MEG are surfaced and the MEG is separated and recycled to maximize operating efficiency and minimize environmental burden. The MEG is typically separated by vaporizing MEG, mixed with water, in a vaporization vessel using a thermal medium. The MEG typically arrives at the vaporizer in a brine mixture and is directly contacted with the thermal medium (i.e. with no material separating the thermal medium from the MEG/water brine mixture) to vaporize the MEG and some of the water. Vaporizing increases concentration of salts in the unvaporized portion, resulting in precipitation of some solids that collect in the thermal medium. The solids are removed from the thermal medium using conventional solids removal means.

The thermal medium is heated to maintain a vaporization temperature. Fluid within the vessel is withdrawn, circulated through a heater, and returned to the vessel. The brine mixture is dispersed into the thermal medium to perform the vaporization. MEG, and some water, vaporizes, moves into the vapor space of the vessel, and is recovered from the vessel vapor space. Mixing of the fluid in the vessel directly affects the rate at which vaporization proceeds. Better mixing in such vaporizers is always desired.

### SUMMARY

Embodiments described herein provide a vaporizer, comprising a vessel having a circular cross-section; a heating pathway comprising a first conduit for withdrawing fluid from the vessel, a heater coupled to the first conduit, and a second conduit coupled to the heater for returning fluid to the vessel; and a fluid distributor disposed within the vessel and fluidly coupled to the second conduit, the fluid distributor comprising a conduit to flow fluid into the vessel in an entry direction; and a circular distribution plate having a central inlet coupled to the conduit and a plurality of peripheral outlets, the circular distribution plate defining a plane, wherein each peripheral outlet is fluidly coupled to the central inlet by a flow path that curves in an azimuthal direction, and each peripheral outlet is shaped to direct fluid flow out of the distributor away from the plane of the circular distribution plate along the entry direction.

Other embodiments described herein provide a vaporizer, comprising a vessel having a circular cross-section; a heating pathway comprising a first conduit for withdrawing fluid from the vessel, a heater coupled to the first conduit, and a second conduit coupled to the heater for returning fluid to the vessel; and a fluid distributor disposed within the vessel and fluidly coupled to the second conduit, the fluid distributor comprising a conduit to flow fluid into the vessel in an entry direction; and a circular distribution plate having a central inlet coupled to the conduit and a plurality of peripheral outlets, the peripheral outlets configured to direct fluid flow along the entry direction and in an azimuthal direction to cause rotation of fluid within the vessel.

Other embodiments described herein provide a method of vaporizing a fluid, comprising flowing the fluid into a vessel containing a thermal medium that is immiscible with the fluid to form a fluid mixture; withdrawing a portion of the fluid mixture from the vessel; heating the withdrawn portion of the fluid mixture; and returning the fluid mixture to the vessel using a fluid distributor, at least a portion of which is immersed in the fluid mixture within the vessel, wherein the fluid distributor is configured to flow the returned fluid into the fluid mixture in a manner that causes the fluid mixture to rotate within the vessel.

### BRIEF DESCRIPTION OF THE DRAWINGS

FIG. 1 is a partial cross-section of a vaporizer according to one embodiment.

FIG. 2 is a cross-sectional view of a portion of the fluid distributor of FIG. 1.

FIG. 3A is a divided view of the portion of FIG. 2.

FIG. 3B is a divided view of a distribution plate according to one embodiment.

FIG. 4 is a simulation of fluid flow within the vaporizer of FIG. 1 during operation thereof, from a top view.

FIG. 5 is a simulation of fluid flow within the vaporizer of FIG. 1 during operation thereof, including the flow of fluid from inlet nozzles of the vaporizer.

FIG. 6 is a simulation of fluid flow within the vaporizer of FIG. 1 during operation thereof from a side view.

### DETAILED DESCRIPTION

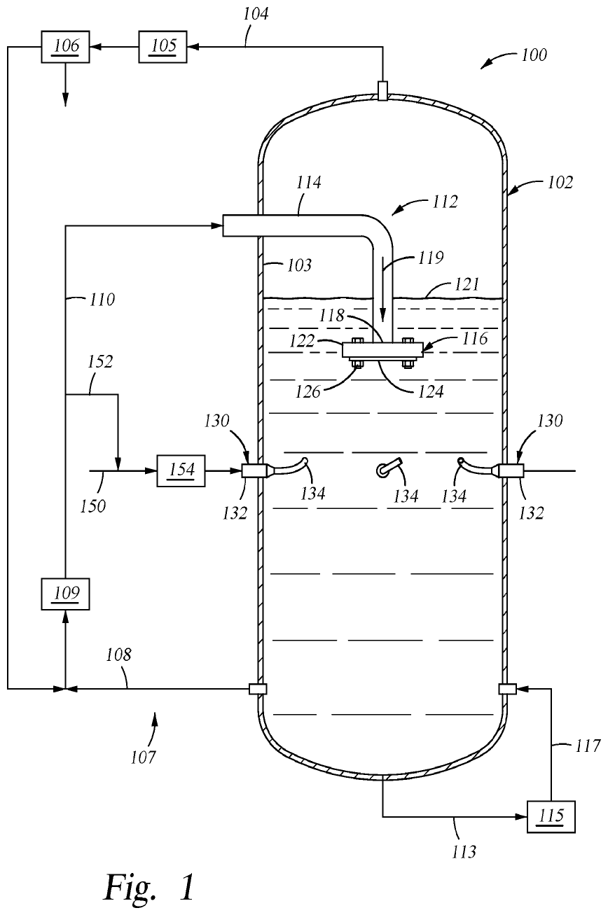

The vaporizers described herein have a vessel with a fluid distributor that maximizes turbulent mixing to minimize size of droplets of the MEG/water mixture within the thermal medium in the vessel. FIG. 1 is a partial cross-section of a vaporizer 100 according to one embodiment. The vaporizer 100 uses a vessel 102 that has a circular cross-section. The vessel 102 is usually cylindrical but other vessels having circular cross-section can also be used. The typical vessel 102 is cylindrical with ellipsoidal ends, but a spherical vessel could be used, for example. The circular cross-section is useful in this case to help develop a flow pattern of fluid within the vessel 102 that promotes mixing, shear, and small droplet size for maximum vaporization rate.

The vessel 102 generally holds a fluid mixture that comprises a thermal medium and a MEG/water mixture that is dispersed in the thermal medium. The thermal medium is immiscible with the MEG/water mixture so that the thermal medium can be easily separated from the MEG/water mixture and returned to the vessel 102. MEG is vaporized, along with some water, by direct contact with the thermal medium in the vessel 102. The MEG/water mixture is dispersed within the thermal medium, and heat from the thermal medium results in vaporization of MEG from the MEG/water mixture. In some cases, the vaporization can entrain droplets of the thermal medium, for example where interfacial turbulence between the fluid and the vapor phase results in small droplets separating from the fluid phase and flowing out with the vapor. The vapor is withdrawn from the vapor space of the vessel 102 through an upper conduit 104.

The vapor is typically condensed in a condenser 105 coupled to the upper conduit 104. The condensed liquid can be sent to a separator 106 to separate any of the thermal medium that exits the vessel 102 through the upper conduit 104. The separator 106 comprises a vessel where the thermal medium and immiscible aqueous medium containing MEG and some water are allowed to settle into two separate liquid phases which can be separately withdrawn. The recovered thermal medium can be returned to the vessel 102. Vapor from the vessel 102 can be routed directly to the separator 106 to allow entrained droplets of the thermal medium to separate from the vapor. The collected liquid can then be returned to the vessel 102. MEG and water recovered from the vapor can be routed to further MEG purification or other suitable purposes.

The thermal medium is heated to maintain the fluid within the vessel 102 at a vaporization temperature. Fluid within the vessel 102 is withdrawn from the vessel in a lower portion thereof, for example from a bottom of the vessel 102, circulated through a heater, and returned to the vessel 102 through a heating pathway 107. The heating pathway 107 has a first conduit 108 coupled to the vessel 102 at a lower part thereof, and to a heater 109. The heating pathway 107 also has a second conduit 110 coupled to the heater 109 and to the vessel 102 to fluidly couple the liquid pool of the vessel 102 through the heating pathway 107 to the vapor space of the vessel 102.

As noted above, the vaporizer 100 vaporizes MEG and some water from a mixture of MEG and water recovered from a hydrocarbon well. The mixture of MEG and water typically contains some solids along with dissolved and/or precipitated salts. As MEG and water are vaporized from the mixture, dissolved salts may be precipitated to increase the solids content of the liquid in the vessel 102. The solids settle to the bottom of the vessel 102 and are typically withdrawn from a bottom location of the vessel in a solids conduit 113. The solids conduit 113 is routed to a solids separation unit 115, which separates the solids using known methods and returns the liquid to the vessel 102 in a return conduit 117 coupled to the solids separation unit 115 and the vessel 102.

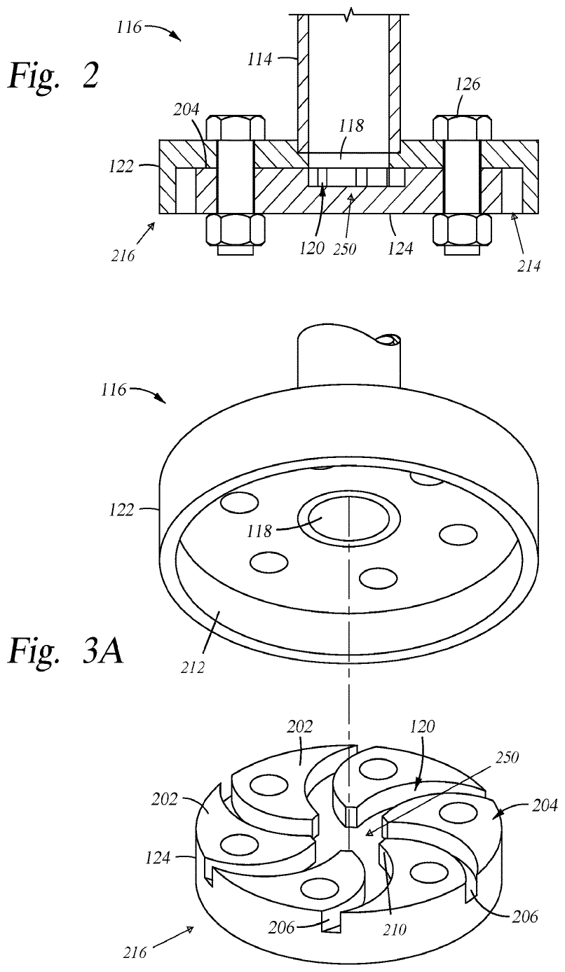

A fluid distributor 112 is disposed within the vessel 102, attached to an interior wall 103 thereof, and fluidly coupled to the second conduit 110. The fluid distributor extends from the vapor space of the vessel 102 into the liquid pool of the vessel 102 during operation thereof. The fluid distributor 112 has a fluid conduit 114 coupled to a circular distribution plate 116 at a central inlet 118 thereof. The fluid conduit 114 is attached to the interior wall 103 of the vessel 102, at a location that, during operation of the vaporizer 100, is typically within the vapor space of the vessel 102. The fluid conduit 114 extends radially inward to a central area 250 of the vessel 102, and turns in an entry direction, denoted by arrow 119, which may be parallel to a central axis of the vessel 102, to couple to the distribution plate 116. During operation of the vessel 102, the distribution plate 116 is typically immersed within the liquid pool of the vessel 102. A schematic phase interface 121 is shown in the vessel 102 for context. The distribution plate 116 has a plurality of peripheral outlets (FIG. 2) configured to direct fluid flow along the entry direction and in an azimuthal direction to cause rotation of fluid within the vessel 102. Fluid flows from the conduit 114 into the distribution plate 116 through the central inlet 118 and out through the peripheral outlets along the entry direction and in an azimuthal direction to cause rotation of fluid within the vessel 102.

The distribution plate 116 has a first member 122 and a second member 124. Each of the first and the second member 122 and 124 is circular. The first and second members 122 and 124 are generally oriented perpendicular to the entry direction 119 of the fluid conduit 114, and may be perpendicular to the central axis of the vessel 102. The first and second members 122 and 124 are typically connected using connectors 126, which may be bolts, but any means can be used. The first member 122 has the central inlet 118, and the space between the first member 122 and the second member 124 forms a flow space for fluid from the fluid conduit 114 to flow through the distribution plate 116. The first member 122 may be a flange of the fluid conduit 114 in some cases.

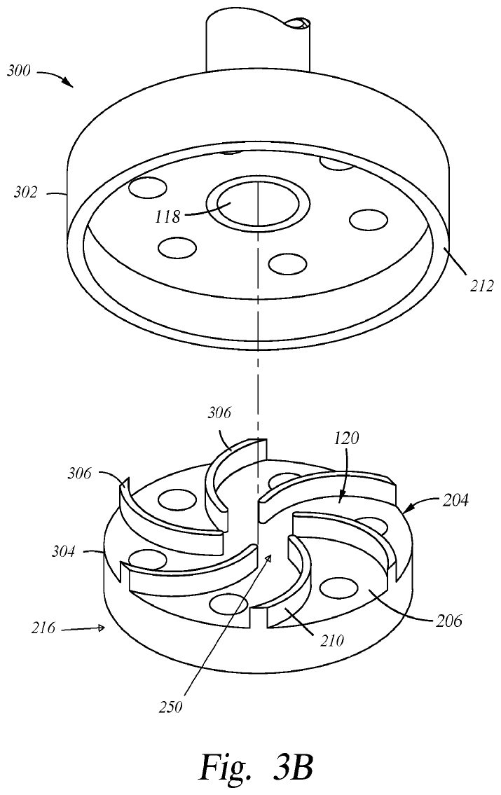

The distribution plate 116 has internal structures 120 to direct fluid flow through the distribution plate 116 according to trajectories that cause the fluid to exit the distribution plate 116 in a flow pattern that induces rotation of the fluid mass within the vessel 102. FIG. 2 is an elevation view of a portion of the fluid distributor 112 of FIG. 1. focused on the distribution plate 116. FIG. 3A is a divided view of the portion of the fluid distributor of FIG. 2. One or both of the first member 122 and/or the second member 124 has features 202 formed in a surface thereof, which at least partially define the internal structures 120. The features 202 are formed in the surface of the member facing inward toward the other member. For example, where the first member 122 has the features 202, the features 202 are formed in a surface 204 of the first member 122 facing the second member 124, and vice versa. The features define fluid flow pathways 120 from a central area 250 of the distribution plate 116, laterally outward to a periphery 216 of the distribution plate 116.

In some cases, the features 202 can be formed in both the first and second members 122 and 124. In such cases, the features 202 can align such that a fluid flow pathway formed in the surface of the first member 122 facing the second member 124 registers with fluid flow pathways formed in the surface of the second member 124 facing the first member 122. In other cases, the features 202 can misalign such that flow pathways defined by the features of the first member 122 can be separated from the flow pathways defined by the features of the second member 124. In such cases, the flow pathways all extend laterally away from the central area 250 of the distribution plate 116 in two sets of flow pathways at two different elevations of the distribution plate 116.

In the version shown in FIGS. 2, 3A, and 3B, the features defining the flow paths through the distribution plate 116 are formed in the surface 204 of the second member 124, which faces a surface of the first member 122 when the first and second members 122 and 124 are assembled together. The features are formed such that the flow paths through the distribution plate 116 are separated by walls 210, which extend from the second member 124 toward the first member 122 and contact the surface of the first member 122 to enclose the flow paths within the distribution plate 116. Where a distribution plate 116 has features formed in the first member 122, such features will extend from the first member 122 toward the facing surface of the second member 124 and contact the surface of the second member 124 to enclose the flow paths.

The second member 124 has a diameter that is less than a diameter of the first member 122. The first member 122 has an outer wall 212 that, when the first member 122 and the second member 124 are assembled, extends along a side of the first member 122 to form an annular flow path 214 in an axial direction of the fluid distributor 112. The features 202 define a plurality of peripheral outlets 206 of the distribution plate 116. The peripheral outlets 206 fluidly communicate with the annular flow path 214 to allow fluid to exit the distribution plate 116. The features 202 are flow directing features, for example vanes or walls, that direct flow of fluid from the central inlet 118 to the peripheral outlets 206 and to the annular flow along a path that changes radial fluid flow at the central inlet 118 into partial azimuthal fluid flow at the peripheral outlets 206. The features 202 modify the trajectory of fluid flow between the central inlet 118 and the peripheral outlets 206 to direct fluid exiting the peripheral outlets 206 in an azimuthal direction that forms an angle with a radius of the distribution plate 116. The fluid flowing out of the peripheral outlets 206 imparts an angular momentum to fluid already in the liquid pool of the vessel 102, in which the distribution plate 116 is immersed, such that the fluid in the liquid pool of the vessel 102 flows in a revolving pattern around the fluid distributor 112 within the vessel 102.

The features 202 here have curved walls that sweep radially outward from the central inlet 118 in a curved pathway that turns the fluid flow in the azimuthal direction. In this case, the features 202 also define a varying flow cross-section that declines from the central inlet 118 to the peripheral outlets 206 to provide a desired exit velocity at the peripheral outlets 206 and to maintain back pressure within the fluid flow system, as further described below.

The peripheral outlets 206 shown in FIG. 2 are located at a side edge of the distribution plate 116 and operate to flow fluid into the annular flow path 214 in an azimuthal direction. The fluid thus flows in the annular flow path 214 in the axial direction of the distributor 112 and also in the azimuthal direction, forming a “curtain” of fluid oriented in the axial direction of the fluid distributor 112, and of the vessel 102, that also revolves around a central axis of the vessel 102 to impart a revolving movement to fluid within the vessel.

In other embodiments, the peripheral outlets 206 may be openings formed through the first member 122 or the second member 124 such that fluid exits the distribution plate 116 through the side of one of the members and not along the side edge of the distribution plate 116. In any case, the fluid is expressed from the distribution plate 116 with components of velocity that are azimuthal, with respect to the vessel 102, and may be axial and/or radial as well. In one case, fluid is expressed from the distribution plate 116 in an axial direction of the vessel 102 and in an azimuthal direction, but not in a radial direction. In that case, the fluid flows out of the distribution plate 116 in a “downward” and “sideward” direction, but not in an “outward” direction.

As shown in FIG. 3A, the features 202 define flow paths, here channels, that curve uniformly in the azimuthal direction from the central area 250 118 of the distribution plate 116 to a periphery 216 thereof. The flow paths may have varying cross-sectional area. In the version of FIG. 3A, the flow paths have a cross-sectional area that is smaller at the periphery 216 of the distribution plate 116 than at the central area 250 118 thereof. Here, the cross-sectional area of each flow path decline smoothly from the central area 250 118 to the periphery 216 of the distribution plate 116. Such configuration operates to maintain back pressure within the fluid distributor 112 as flow flows through the fluid distributor 112.

In other cases, the flow paths of the distribution plate 116 can have expanding cross-sectional area from the central area 250 118 to the periphery 216 thereof. FIG. 3B is a divided view of a distribution plate 300, according to another embodiment. The distribution plate 300 can be used as part of a fluid distributor, such as the fluid distributor 112, in a vaporizer like the vaporizer 100. The distribution plate 300 has a first member 302 and a second member 304, the second member 304 having features 306 that define flow paths through the distribution plate 300. The features 306, in this case, are vanes internal to the distribution plate 300 and extending from the second member 304 toward a facing surface of the first member 302. When the first and second members 302 and 304 are assembled together the vanes of the second member 304 make contact with the facing surface of the first member 302 to enclose flow paths between the vanes.

The vanes extend from the central area 250 118 of the distribution plate 300 to the periphery 216 thereof, have uniform thickness, and curve uniformly in an azimuthal direction, reaching the periphery 216 and forming an angle with the periphery 216 of the distribution plate 300 that is not a right-angle. Here the vanes are not connected, other than being attached to the same surface of the second member 304. In other cases, the vanes could connect at the central area 250 118 of the distribution plate 300. The vanes could have non-uniform thickness in some cases.

It should be noted here that the first member 302 is substantially identical to the first member 122 of the distribution plate 116. The distribution plate 116 is configured such that the second member can be swapped, and different configurations can be used from time to time. For example, in one fluid distributor, the second member 124 could be used, and could be swapped for the second member 304.

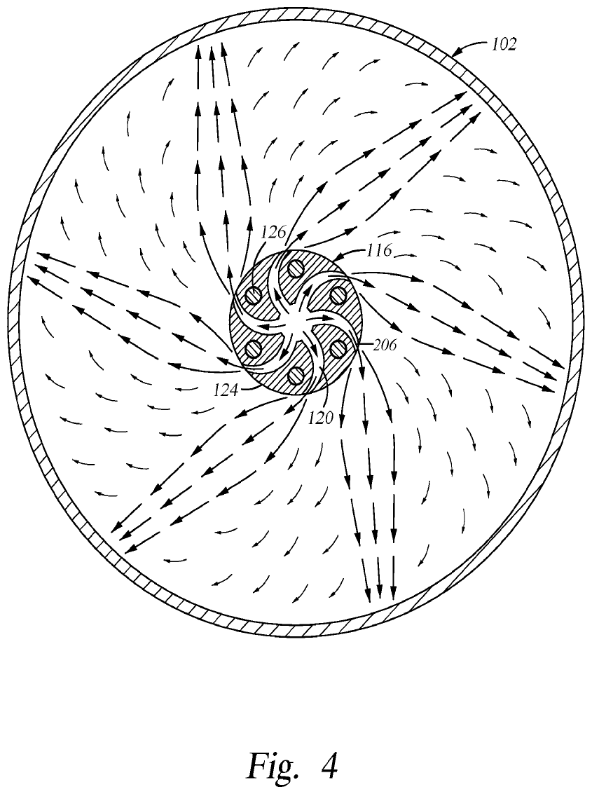

FIG. 4 is a simulation of fluid flow within the vessel 102 during operation of the fluid distributor 112, from a top view. In this case, the fluid distributor 112 has 6 fluid flow pathways 120 exiting in 6 peripheral outlets 206. The simulation shows the effect of the fluid exiting the peripheral outlets 206. The azimuthal angle of fluid flow from the peripheral outlets 206 of the distribution plate 116 imparts angular momentum to the fluid in the liquid pool of the vessel 102, causing the liquid pool to revolve about the fluid distributor 112. In general, the fluid motion imparted to the liquid mass within the vessel by the distribution plate 116 is orbital, for example irrotational, and non-vortical, but some embodiments may be configured to produce rotation with non-zero vorticities. In this case, the distribution plate 116 has a diameter selected to result in a fluid velocity at the peripheral outlets 206 that enables a core of fluid flowing from the peripheral outlets 206 to reach the interior wall 103 of the vessel 102, but such flow characteristics are not necessary to induce rotation of the fluid mass within the vessel 102. Here, the azimuthal angle of fluid flow trajectory at the peripheral outlets of the distribution plate 116 is 45 degrees for each outlet, but any desired angle, for example from 10 degrees to 80 degrees with respect to the radial direction, can be used.

Referring again to FIG. 1, as noted above, the fluid exiting the fluid distributor 112 is fluid that has been withdrawn from the vessel 102 and returned to the vessel 102 after heating. New fluid, comprising MEG and water, is provided to the vessel 102 through a plurality of fluid inlet nozzles 130 extending from the interior wall 103 into the vessel 102 interior. The fluid inlet nozzles 130 are all configured to direct fluid flow into the vessel 102, within the liquid pool of the vessel 102, in a direction generally toward the distribution plate 116. The nozzles 130 are configured to direct fluid flow into the vessel 102 in a radial direction of the vessel 102 and in at least one of the axial direction of the vessel 102 and an azimuthal direction of the vessel 102. Where the nozzles 130 direct fluid flow in the axial direction of the vessel 102, the direction is generally toward the distribution plate 116. Where the nozzles 130 direct fluid flow in the azimuthal direction of the vessel 102, the direction is generally opposite to the rotational motion of the fluid within the vessel 102. Each inlet nozzle 130 extends inward along a radius of the vessel 102 and turns toward the fluid distributor 112 at an end of the nozzle 130. Each inlet nozzle 130 has a body 132 and a tip 134 that form an angle. The body 132 of each nozzle 130 is attached to the interior wall 103 of the vessel 102 and extends radially inward from the interior wall 103. Each tip 134 is pointed toward the distribution plate 116 and also extends radially inward such that fluid flow from each nozzle 130 is along a radius of the vessel 102 and toward the distribution plate 116.

As noted above, fluid flows into the distribution plate 116 in an entry direction. Each tip 134 extends in a direction opposite from the entry direction, in addition to extending radially inward. It should be noted that the nozzle tips 134 could be oriented at least partially in a direction opposite to the direction of fluid circulation induced by fluid flowing out of the distribution plate 116. Thus, the non-radial extension of each tip 134 could be entirely in an axial direction of the vessel 102, entirely in an azimuthal direction of the vessel 102, or in both the axial and the azimuthal direction of the vessel 102. In this case, the tips 134 are oriented entirely in the axial direction of the vessel 102.

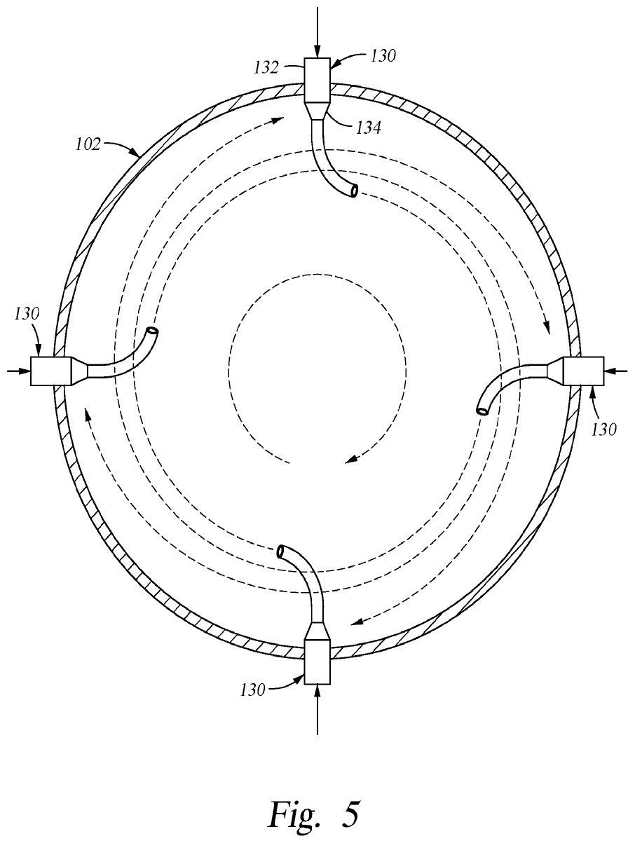

FIG. 5 is a simulation of fluid flow within the vessel 102 during operation of the vessel 102 from a top view, but including the flow of fluid from the inlet nozzles 130. As shown in FIG. 5, rotation of the fluid mass within the vessel 102 deflects flow of fluid from the inlet nozzles 130 from a radial trajectory to an azimuthal trajectory resulting in a first shear component applied to the inlet fluid.

The peripheral outlets 206 and annular flow path 214 of the distribution plate 116 are configured to project fluid out of the distribution plate 116 and toward the inlet nozzles 130. Thus fluid from the distribution plate 116 and fluid from the inlet nozzles 130 flow toward each other, as the vessel 102 of FIG. 1 is configured. In the case described above where fluid is expressed from the distribution plate in an axial and azimuthal direction of the vessel 102, but not in a radial direction, relative to a plane defined by the distribution plate 116, the peripheral outlets 206 are configured to direct flow at a 90 degree angle. Thus, in one sense, the peripheral outlets 206 could be said to direct fluid flow “straight downward” within the vessel 102 to form a fluid curtain and the inlet nozzles 130 could be said to direct fluid flow “upward” within the vessel 102. In this case, the nozzles 130 are positioned and configured to direct inlet fluid toward the “top” of the fluid curtain formed by the peripheral outlets 206, which is the location where fluid exits the distribution plate 116. In any event, fluid flow from the peripheral outlets 206 and the inlet nozzles 130 is at least partially in opposite directions (“upward” and “downward”). The opposing flow results in a second component of shear applied to the inlet fluid.

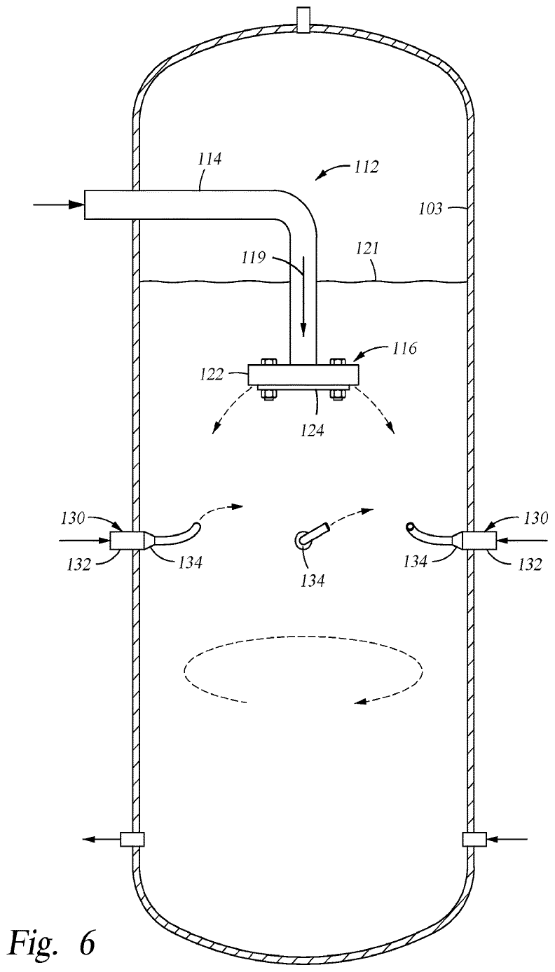

FIG. 6 is a simulation of fluid flow within the vessel 102 during operation of the vessel 102 from a side view. Fluid flow from the distribution plate 116 is shown projecting “downward” within the vessel 102 toward the inlet nozzles 130. The fluid flow from the distribution plate 116 creates a fluid “curtain” with azimuthal flow direction to cause rotation of the fluid mass within the vessel 102 along with vertical circulation of the fluid mass within the vessel 102. The multiple flow trajectories within the vessel 102 maximize mixing of fluids and exposure of the inlet fluid to hot thermal medium to maximize evaporation rate within the vessel 102.

The inlet fluid charged to the vessel 102 using the inlet nozzles 130 may be contacted with thermal medium fluid prior to entry into the vessel 102. Referring again to FIG. 1, a portion of the fluid withdrawn from the vessel 102, for example in the heating pathway, can be mixed with the inlet fluid outside the vessel 102. As shown in FIG. 1, the inlet fluids can be routed through a first inlet conduit 150, and heated thermal medium fluid from the heating pathway can be routed through a second inlet conduit 152 to intersect with the first inlet conduit 150 to mix the two fluid flows, for example using a T-connector. A mixing device 154, such as static mixer, can be used to enhance mixing of the inlet fluid with the thermal medium prior to entry into the vessel 102. A quantity of thermal medium pre-mixed with the inlet fluids can be used to control vaporization rate along with inlet jet characteristics of fluid exiting the nozzles 130. Flow rate of the thermal medium mixed with the inlet fluids can be controlled using standard flow control devices.

It should be noted that some embodiments of vaporizers can have multiple fluid distributors such as the fluid distributor 112. In such cases, ach such fluid distributor is generally configured like the fluid distributor 112, but the number of fluid pathways and peripheral outlets, and the azimuthal and axial fluid flow angle at the peripheral outlets, may be different. Also, the azimuthal direction, tending to cause “clockwise” or “anti-clockwise” fluid circulation, can be different for the different fluid distributors. In one case, a plurality of fluid distributors having different flow directions that can be used in one vessel such as the vessel 102. For example, multiple fluid distributors, for example four fluid distributors, having opposing ejection flow angles, in clockwise and anti-clockwise flow configurations, can be used in any mixture. The multiple flow distributors can have distribution plates located at the same axial location of the vessel, or at different axial locations of the vessel. For example, a first plurality of distributors can be located within the vessel such that the first plurality of distributors has distribution plates located at a first axial location with the vessel, and a second plurality of distributors can be located within the vessel such that the second plurality of distributors has distribution plates located at a second axial location within the vessel, different from the first axial location.

It should also be noted that inlet nozzles such as the nozzles 130 can be located at the same axial location of the vessel 102 or at different axial locations, and that more than one “rank” of inlet nozzles can be used, each rank of inlet nozzles having the same, or similar, axial location. For example, in the embodiment shown in FIG. 1, additional inlet nozzles can be located “above,” “below,” and/or at elevation co-incident with the distribution plate 116 of the fluid distributor 112. Said another way, the nozzles could have axial locations within the vessel 102 that are on either side, in the axial direction of the vessel 102, of the distribution plate 116, such that the distribution plate 116 has an axial location within the vessel 102 that is between at least one pair of the nozzles. The nozzles of FIG. 1 have tips that all point the same direction, but the tip direction could be varied according to different embodiments. For instance, where nozzles are located on opposite sides of the distribution plate 116 in the axial direction of the vessel 102, the nozzle tips could be oriented with opposing flow components in the axial direction such that the nozzles all point toward the distribution plate 116, from “above” and “below”. In the embodiment of FIG. 1, the end of each nozzle tip 134 is located about halfway between the interior wall 103 and the outer edge of the distribution plate 116, but such location can be optimized for particular objectives.

The heating pathway 107 and the fluid distributor 112 are generally configured to prevent unwanted vaporization of fluid components therein. Thus, the piping and the distribution plate 116 are configured to perform the two functions of 1) directing fluid in a direction and with a velocity to impart a desired flow pattern of the liquid mass within the vessel 102, and 2) to maintain back pressure within the heating pathway 107 and fluid distributor 112 above any vapor pressures of the fluid circulating through the heating pathway 107 and the fluid distributor 112. These results are obtained generally by sizing the peripheral outlets 206 and the flow pathways defined by the features 202 to provide sufficient back pressure at design fluid flow rates. The design fluid flow rates generally depend on the needed pattern of fluid flow within the vessel 102, which depends on size of the vessel 102 and size of the distribution plate 116 relative to the vessel 102. In one case, an 8 inch diameter distribution plate is used in a vessel having a diameter of 24 inches. In general, the distribution plate 116 has a first diameter, which is a diameter of the distribution plate 116 at the outer edge thereof, and the vessel 102 has a second diameter, which is a diameter of the vessel 102 at the interior wall 103 thereof. A ratio of the first diameter to the second diameter may be from about ¼ to about ⅓ for good mixing results, depending on other characteristics and structural components that may be present. Generally speaking, if the first diameter is too small relative to the second diameter mixing will be less than desired, and if the first diameter is too large relative to the second diameter, upward vapor transport within the vessel 102 is impeded.

The flow components described herein are configured to flow fluid in oppositional and circulatory ways to maximize mixing and contacting of fluids in the vaporizer. It is believe that maximizing mixing and contacting results in smaller droplets of fluid to be subjected to vaporization dispersed within the immiscible thermal medium. Smaller droplets reduces time and distance for heat to flux into the fluid to be subjected to vaporization and reduces time and distance for fluid to transport from interior locations of such droplets to the surface of the droplet to become vaporized.

The preceding description has been presented with reference to present embodiments. Persons skilled in the art and technology to which this disclosure pertains will appreciate that alterations and changes in the described structures and methods of operation can be practiced without meaningfully departing from the principle, and scope of this present disclosure. Accordingly, the foregoing description should not be read as pertaining only to the precise structures described and shown in the accompanying drawings, but rather should be read as consistent with and as support for the following claims, which are to have their fullest and fairest scope.

1. A vaporizer, comprising:
a vessel having a circular cross-section;
a heating pathway comprising a first conduit for withdrawing fluid from the vessel, a heater coupled to the first conduit, and a second conduit coupled to the heater for returning fluid to the vessel; and
a fluid distributor disposed within the vessel and fluidly coupled to the second conduit, the fluid distributor comprising:
a conduit to flow fluid into the vessel in an entry direction; and
a circular distribution plate having a central inlet coupled to the conduit and a plurality of peripheral outlets, the circular distribution plate defining a plane, wherein each peripheral outlet is fluidly coupled to the central inlet by a flow path that curves in an azimuthal direction, and each peripheral outlet is shaped to direct fluid flow out of the distributor away from the plane of the circular distribution plate along the entry direction.

2. A vaporizer, comprising:
a vessel having a circular cross-section;
a heating pathway comprising a first conduit for withdrawing fluid from the vessel, a heater coupled to the first conduit, and a second conduit coupled to the heater for returning fluid to the vessel; and
a fluid distributor disposed within the vessel and fluidly coupled to the second conduit, the fluid distributor comprising:
a conduit to flow fluid into the vessel in an entry direction; and
a circular distribution plate having a central inlet coupled to the conduit and a plurality of peripheral outlets, the peripheral outlets configured to direct fluid flow along the entry direction and in an azimuthal direction to cause rotation of fluid within the vessel.

3. The vaporizer of claim 1, further comprising a plurality of fluid inlet nozzles at a wall of the vessel, each fluid inlet nozzle located a distance from the plane of the distribution plate and oriented to direct fluid flow into the vessel toward the distribution plate, wherein each peripheral outlet of the distribution plate is shaped to direct fluid flow toward the fluid inlet nozzles.

4. The vaporizer of claim 1, further comprising a plurality of fluid inlet nozzles at a wall of the vessel, each fluid inlet nozzle oriented to direct fluid flow into the vessel in a radial direction and in a direction opposite to the entry direction.

5. The vaporizer of claim 1, wherein the peripheral outlets of the distribution plate direct fluid flow downward from the fluid distributor and the fluid inlet nozzles direct fluid flow upward within the vessel.

6. The vaporizer of claim 1, wherein each flow path of the distribution plate has a varying cross-sectional area.

7. The vaporizer of claim 1, wherein the distribution plate comprises a first member having the flow paths formed at a surface thereof and a second member coupled to the first member with said surface of the first member facing the second member.

8. The vaporizer of claim 7, wherein the first member has a diameter smaller that the second member, and the second member has an outer wall that, when the first member and the second member are assembled, extends along a side of the first member to form an annular flow path to the peripheral outlets in an axial direction of the fluid distributor.

9. The vaporizer of claim 1, wherein the distribution plate comprises a plurality of internal vanes having uniform thickness, extending from a central area 250 of the distribution plate to a periphery of the distribution plate and curving uniformly in the azimuthal direction to define the flow paths.

10. The vaporizer of claim 1, wherein the flow paths of the distribution plate consist of a plurality of channels extending from a central area 250 of the distribution plate to a periphery of the distribution plate and curving uniformly in the azimuthal direction, the channels having a smaller cross-sectional area at the periphery of the distribution plate than at the central area 250 of the distribution plate.

11. The vaporizer of claim 1, wherein the distribution plate comprises a first member and a second member having the flow paths formed at a surface thereof, the second member is coupled to the first member with said surface of the second member facing a surface of the first member, and wherein the flow paths are separated by walls that extend from the second member and contact the surface of the first member.

12. The vaporizer of claim 1, wherein the distribution plate directs fluid flow into the vessel to cause non-vortical rotation of fluid in the vessel.

13. The vaporizer of claim 3, wherein the distribution plate directs fluid flow into the vessel to cause non-vortical rotation of fluid in the vessel and the fluid inlets are oriented to direct fluid flow into the vessel in a direction opposite to the non-vortical rotation.

14. A method of vaporizing a fluid, comprising:
flowing the fluid into a vessel containing a thermal medium that is immiscible with the fluid to form a fluid mixture;
withdrawing a portion of the fluid mixture from the vessel;
heating the withdrawn portion of the fluid mixture; and
returning the fluid mixture to the vessel using a fluid distributor, at least a portion of which is immersed in the fluid mixture within the vessel, wherein the fluid distributor is configured to flow the returned fluid into the fluid mixture in a manner that causes the fluid mixture to rotate within the vessel.

15. The method of claim 14, further comprising injecting the fluid into the vessel toward the returned fluid as the returned fluid is flowed into the fluid mixture.
